(19) United States
(12) Patent Application Publication
(10) Pub. No.: US 2004/0136004 A1
(43) Pub. Date: Jul. 15, 2004

(54) Portable color reader and display device

(76) Inventor: Michael Keith Collins, Cupertino, CA (US)

Correspondence Address: MICHAEL K. COLLINS, 10285 MORETTI DRIVE, CUPERTINO, CA, 95014, US

(21) Appl. No.: 10/345,638

(22) Filed: Jan. 15, 2003

(51) Int. Cl. G01N 21/55

(52) U.S. Cl. 356/445

(57) ABSTRACT

A portable, hand held, color reading device is provided for determining and displaying the color of an object. This device illuminates the object with series of colored light pulses produced by multiple Light Emitting Diodes, commonly called LEDs. The device has six LEDs, Red, Orange Yellow, Green, Bluish Green, and Blue, but additional LEDs may be used for finer color measurement and fewer LEDs may be used for coarser color measurement. The object's spectral reflectance is determined by measuring the reflected light during each LED's light pulse by a photo detector. The object color is then determined by comparing the relative strengths of the light reflectance that is measured during each LED color illumination. The Color may be displayed on the device's LCD, or read by a host computer through a PC I/O interface for use within Application software. The object's color may be displayed in various selectable color formats.

### CROSS-REFERENCE TO RELEATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to portable color readers, specifically to such portable color readers which are hand held and display the name of the read color.

### BACKGROUND OF THE INVENTION

Color identification and color matching, in the home painting market, has traditionally been a time-consuming and imprecise process. Currently, consumers must bring paint chips to paint suppliers in order to match the color they desire. Such paint suppliers have provided paper paint color swatches to aid consumers in their color selections, however, the perceived color changes with lighting often resulting in a difference between the color that was viewed at the store and the color that is viewed in sunlight or at the consumers home. Paint suppliers have also spent thousands of dollars to install color matching equipment that requires a trained operator and is not directly available to the consumer.

### BACKGROUND OF THE INVENTION—OBJECTS AND ADVANTAGES

Accordingly, several objects and advantages of the present invention are:

(a) to provide a means to match the color of an objects at different locations, such as the wall of a home and the paint in a retail outlet.

(b) to provide a portable, light weight, hand held, device for reading and displaying a color name.

(c) to provide a color reading device that reads color with an accuracy similar to that of the human eye.

(d) to provide a color reading device that displays the read color on the device.

(e) to provide a color reading device that interfaces with a personal computer allowing the read color to be transferred to the personal computer.

### SUMMARY

In accordance the present invention a color reading and display device comprised of portable pen shaped body, having:

(a) a color reading instrumentation

(b) a character display along the side which displays the read color

(c) a personal computer interface which allows the read color information to be transferred to or transferred from a computer.

### DRAWINGS—FIGURES

FIG. 1 shows the preferred embodiment of the invention

FIG. 2. Block Diagram of Processing System

FIG. 3. LED Reflected Light on Photo Detector Circuit

FIG. 4. Photo Detector Circuit using a Photo Transistor

FIG. 5. LED & Photo Detector Construction

FIG. 6. Cone between Object and Photo Detector

FIG. 7. Cover with Calibration Target

### DETAILED DESCRIPTION

A portable, hand held, color reading device is provided for determining and displaying the color of an object. This device illuminates the object with series of colored light pulses produced by multiple Light Emitting Diodes, commonly called LEDs. The device has six LEDs, Red, Orange Yellow, Green, Bluish Green, and Blue, but additional LEDs may be used for finer color measurement and fewer LEDs may be used for coarser color measurement. The object's spectral reflectance is determined by measuring the reflected light during each LED's light pulse by a photo detector. The object color is then determined by comparing the relative strengths of the light reflectance that is measured during each LED color illumination. The Color may be displayed on the device's LCD, or read by a host computer through a PC I/O interface for use within Application software. The object's color may be displayed in various selectable color formats.

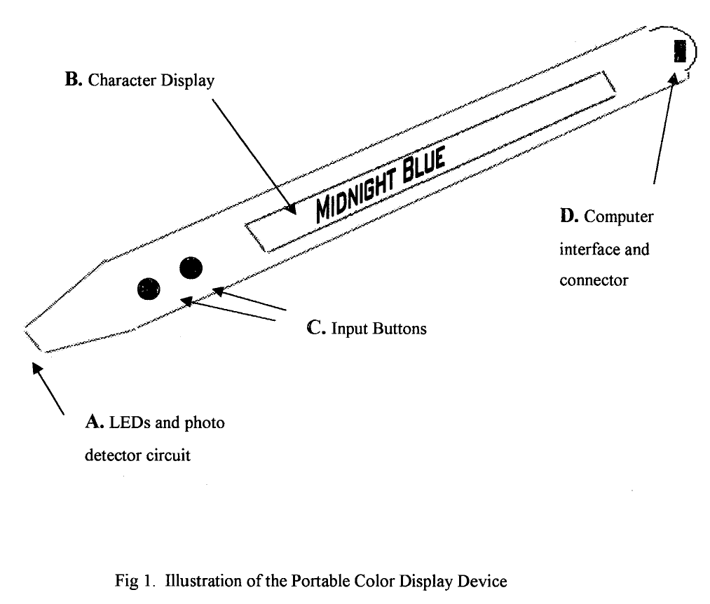

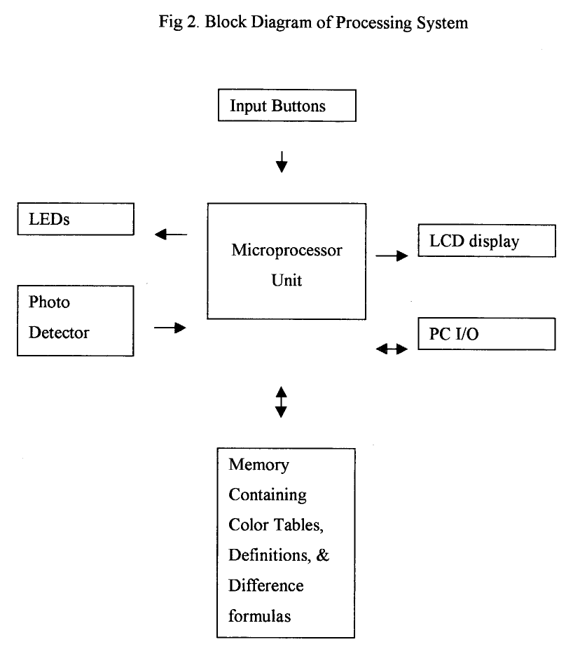

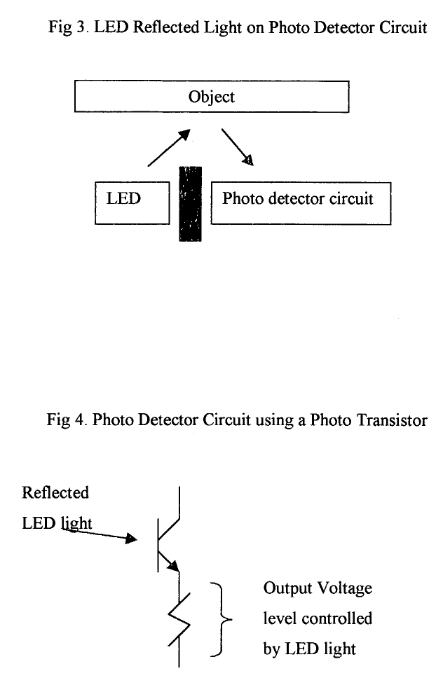

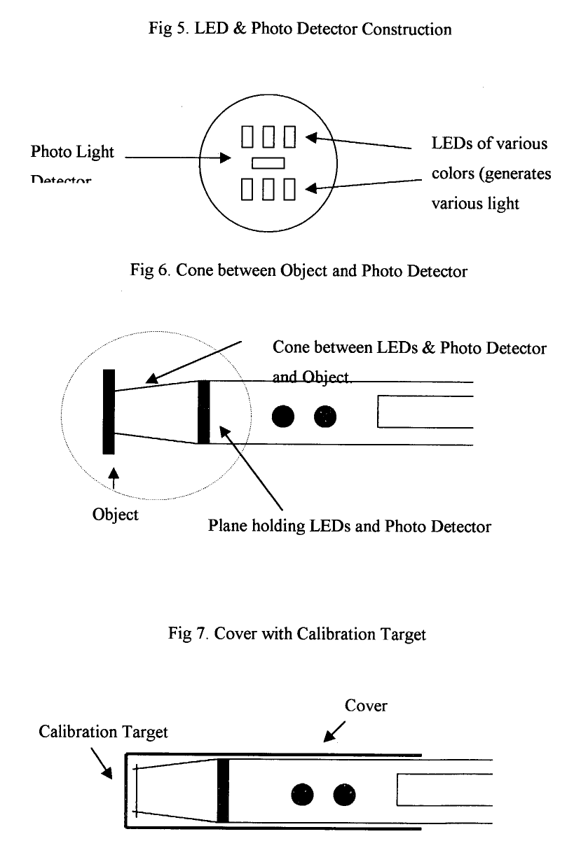

A preferred embodiment of the present invention is illustrated in FIG. 1.

The Color Reader consists of a microprocessor, multiple colored LEDs, a photo detector circuit, a LCD display, a PC 1/O interface, input buttons, and programmable memory.

An object's color is read by moving the device so that device's photo detector (FIG. 1-A) is against the object and presses an input button (FIG. 1-B). The “button press” interrupts the microprocessor from a low power state and starts a sequence of internal operations, controlled by firmware, that result in the display of the object's color on the device's LCD (FIG. 1-C).

The Color Reader displays the object's color on the LCD in one of two forms, depending upon the type of Color Table that has been loaded into the color table memory.

1) If a CONTINOUS color table is installed and selected, which contains a continues color naming definition, such as CIELAB, the color's name is displayed.

2) If a FINATE color table is installed and selected, which contains finite set of defined color names, such as a manufacture's paint list, the “closest defined color” is displayed with numeric indicating the difference between the “read color” and the “closest defined color”.

The Color Reader can be attached to a PC's I/O port by a connector on the device. The PC I/O can be used at any time to interface the device to an external computer and, thereby, allow the operator to update the Color Table memory with a new or modified color space tables/definitions.

The Color Reader measures an object's color by weighing the strength of reflected light. Specifically, it uses multiple LEDs to illuminate the object with their corresponding wavelengths of light, and measures the light reflected by means of the photo detector circuit. The LEDs are selected so that their dominant wavelengths are disbursed throughout the visible spectrum. The six LED version of this device uses, Red, Orange, Yellow, Green, Bluish Green, and Blue LEDs. The photo detector must be able to detect all wavelengths of visible light

The LEDs illuminate an area that is large enough to assure a sufficient reflectance area providing a “color average” for objects with surfaces that are not smooth, such as cloth, textiles, or skin.

The Color Reader begins a reading by “turning-on” a single LED which illuminates the object with light of the LED's wavelength. The Color Reader then reads the voltage generated by the light reflected from the object onto the photo detector circuit. Upon completion of the measurement, the LED is “turned-off”. The length of the light pulse is minimized to prevent thermal changes in the LED or Photo detector circuit. The photo detector is shielded from direct LED light by an opaque wall.

The remaining LEDs are read in sequence, in a procedure identical to the first, where each LED is used to illuminate the object with its dominate wavelength and the corresponding reflected light is measured as a voltage generated by the photo detector circuit.

The distance between the LEDs & Photo Light Detector is within 10 millimeters. A cone between the object and the LEDs & photo detector establishes and maintains this distance. The inside surface of the cone may be black or may have a reflective mirror type coating, allowing greater illumination of the object.

For a correct color reading, external light must be eliminated from the surface that is being measured. The tip of the cone, which is placed against the object, may be made of a pliable material such as rubber to ensure a seal against external light.

The microprocessor normalizes the six voltage readings, adjusting their strengths with respect to each LED's gray curve, and a calibration that occurs when the Color Reader is powered-on. This normalization allows for variances between LEDs, variances in the physical location of the LEDs with respect to the Photo Detector, and the spectral detection variance of the photo detector. The actual physical location of the LEDs is, therefore, not critical.

The microprocessor then compares the adjusted color strengths to determine the objects HUE, LIGHTNESS, and SAURATION.

Once the color has been determined, the Color Reader may either display the color on the LCD or display the closest defined color from an internal color table and a value indicating the difference between “closest color” and the “object's color”.

The value indicating the color difference may be displayed as a numeric multi-dimensional vector or as a set and quantity of ink or pigments to add to the closest color to reach the object's color.

The device is powered-on by removing a COVER or CAP, which also serves a calibration target. As the COVER is removed a color reading occurs allowing the device to adjust to environmental changes such as temperature and battery power.

Upon a command from the external computer, the Color Reader processes and returns the read color data.

When COVER is replaced, power is removed preserving battery life and providing a means of protecting the LEDs and Photo Detector from physical damage.

The color reader's internal color tables can be changed at any time by means of an interface cable inserted between an external computer and the device. This allows the device to adapt to changes in a paint manufacturer's product line; as paint colors are added or removed the device's color tables can be adjusted accordingly.

The personal computer interface also allows the Color Reader to serve as a color input device for Applications Software.

I claim:

1. A portable, hand held, device for measuring and displaying spectral reflectance of an object, comprising:
multiple illuminations of an object at various light wavelengths, by means of various LEDs, that are measured in series by a photo detector; and
the various light (LED pulses) measurements are weighed, compared, and processed to determine the spectral visible light reflectance of the object. The specific location of the LEDs with respect to the Photo Detector is not critical since adjustments are made, within the device, for variances between LED light strengths.

2. A device as defined in claim 1 where the object's color name is displayed in a selectable color space/format or any color naming convention that defines a color; and
the object's color name is displayed, either by an attached LCD, or other display device, or through a host computer attached to the device by a computer interface such as USB or RS-232; and
and the displayed color space/format can be SET and/or MODIFIED to any other color naming definition such as CIELAB, CIEXYZ or the unique color names of a given manufacturer's paint, ink, or other product identified fully or in part by color.

3. A device as defined in claim 1 and claim 2 that is portable in shape and size allowing a mobility required to read an object's color without requiring the object to be moved or placed within the device, or parts of the device; and
allowing the device to be stored in a small location such as a “shirt pocket” or a fountain pen case or dispenser; and
allowing the color of objects without smooth surfaces or hard surfaces to be read and measured, such as cloth or textiles, or skin.
